(19) United States
(12) Patent Application Publication
(10) Pub. No.: US 2008/0060396 A1
(43) Pub. Date: Mar. 13, 2008

(54) Vehicle compartment locking apparatus

(76) Inventor: Steven M. Harvey, Austin, TX (US)

Correspondence Address: MICHAEL O. SCHEINBERG, P.O. BOX 164140, AUSTIN, TX, 78716-4140, US

(21) Appl. No.: 11/825,137

(22) Filed: Jul. 2, 2007

Related U.S. Application Data
(60) Provisional application No. 60/817,930, filed on Jun. 30, 2006.
(60) Provisional application No. 60/855,858, filed on Nov. 1, 2006.

(51) Int. Cl. E05B 65/12; B60R 25/00; E05B 47/00

(52) U.S. Cl. 70/237; 70/263

(57) ABSTRACT

An improved actuator used to operate one or more locks on a vehicle. Preferred embodiments of the present invention are configured to lock and unlock multiple locks sequentially rather than simultaneously, allowing for the use of smaller and less expensive motors. Actuator nosepieces can also be changed out allowing the actuators to be easily used with different kinds of locking mechanisms. The actuating member is locked and unlocked by way of a compression spring and plunger assembly that is more robust than a torsion spring as in prior art.

This application claims priority from U.S. Provisional App. No. 60/817,930 filed Jun. 30, 2006, and from U.S. Provisional App. No. 60/855,858 filed Nov. 1, 2006, both of which are hereby incorporated by reference.

### TECHNICAL FIELD OF THE INVENTION

The invention relates to vehicle security devices, more particularly to electrical and pneumatic vehicle compartment locks.

### BACKGROUND AND SUMMARY OF THE INVENTION

Theft and/or unauthorized use of vehicles and theft of items inside vehicles are a major problem for the owners. While many security measures, such as locks or alarms, are well known in the prior art, most are somewhat inconvenient for the owner or operator of the vehicle. This convenience will often lead an operator to choose to avoid using the vehicle security measure, thus compromising the security of the vehicle or items within the vehicle.

For example, multiple storage compartments are built into a variety of vehicles such as rescue emergency units, ambulances, service trucks and delivery vans. Locks designed for the doors of these compartments typically are key operated. It is time consuming, especially when a vehicle has a plurality of compartments, to move to each door and lock or unlock it. Electrically operated locking systems are known, bust most are installed at the factory. It can be difficult and expensive to retrofit existing trucks.

Further, prior art electrically operated locking systems which open multiple locks on multiple compartments simultaneously produce a very high amperage spike when the locks are operated. This can put a significant strain on a vehicle's electrical system and can require heavy-duty wiring and fuses.

U.S. Pat. No. 5,493,881 to the Applicant for “Electric Door Lock for Vehicle Storage Compartments,” which is herby incorporated by reference, teaches the use of an electrically operated actuator to open and close vehicle locks. The actuator has an actuating member movable between first and second positions which move a cam between an unlocked position spaced from a lock bolt to a locked position blocking movement of the lock bolt. This prior art actuator, however, suffers from a number of shortcomings.

Also, keypads on vehicle doors allow access to someone who does not have a key or electric key fob. Most keypads are installed at the factory. After-market installation typically requires extensive wiring and cutting holes in the vehicle body.

Further, electrical locking systems are undesirable for situations such as marine use where the system must be waterproof or for situations requiring explosion-proof equipment.

Finally, prior art electrically operated locking systems which open multiple locks on multiple compartments simultaneously produce a very high amperage spike when the locks are operated. This can put a significant strain on a vehicle's electrical system and can require heavy-duty wiring and fuses.

What is needed is an improved system for more conveniently locking and opening various vehicle security systems.

### SUMMARY OF THE INVENTION

An object of the invention, therefore, is to provide an improved system for more conveniently locking and opening various vehicle security systems.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1A shows an actuator with a detachable nosepiece that attaches directly to a pin or bolt on a lock cam according to a preferred embodiment of the present invention.

FIG. 1B shows an actuator with a detachable nosepiece that attaches to an extension rod, which in turn attaches to a lock cam according to a preferred embodiment of the present invention.

FIG. 1C shows an actuator with a detachable nosepiece that is shaped so that it pushes between the bolt and the lock cam according to a preferred embodiment of the present invention.

FIG. 2 shows a key and slot assembly for mounting detachable actuator nosepieces according to a preferred embodiment of the present invention.

FIG. 3A and FIG. 3B show an actuator according to a preferred embodiment of the present invention.

FIG. 4A shows a plunger and spring according to a preferred embodiment of the present invention.

FIG. 4B shows a plunger and an actuating member piston according to a preferred embodiment of the present invention.

FIG. 4C shows the contact surface of a plunger according to a preferred embodiment of the present invention.

### DETAILED DESCRIPTION OF PREFERRED EMBODIMENTS

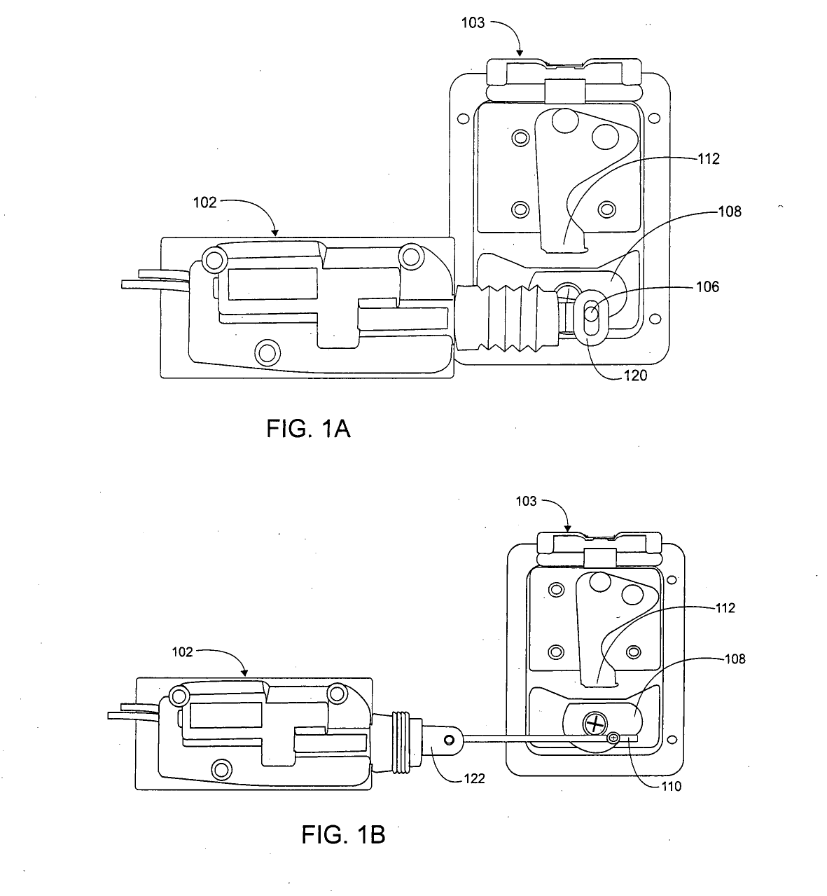

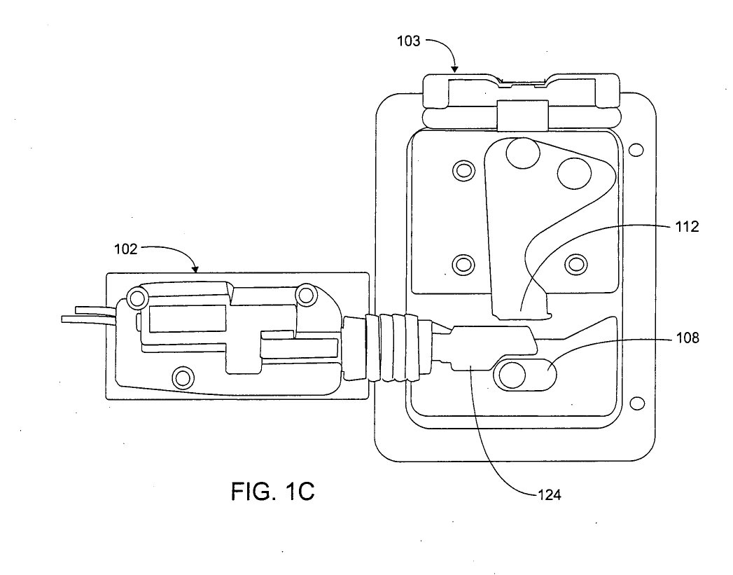

In one preferred embodiment of the present invention, an improved actuator is used to operate one or more locks on a vehicle. Several different actuator nosepieces can be used. For example, FIG. 1A shows an actuator 102 with a nosepiece 120 with a round head that attaches directly to a pin or bolt 106 on a lock cam 108. FIG. 1B shows an actuator nosepiece 122 with a small hole in the nosepiece head suitable for attaching to an extension rod 110, which in turn attaches to a cam 108. FIG. 1C shows an actuator nosepiece 124 that is shaped so that it pushes between the bolt 112 and the cam 108. In the prior art, actuators were manufactured and sold with a particular nosepiece.

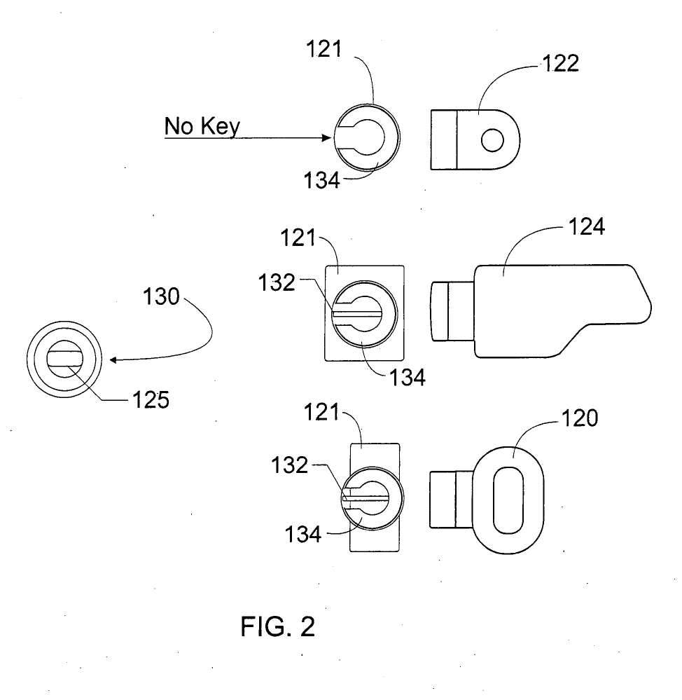

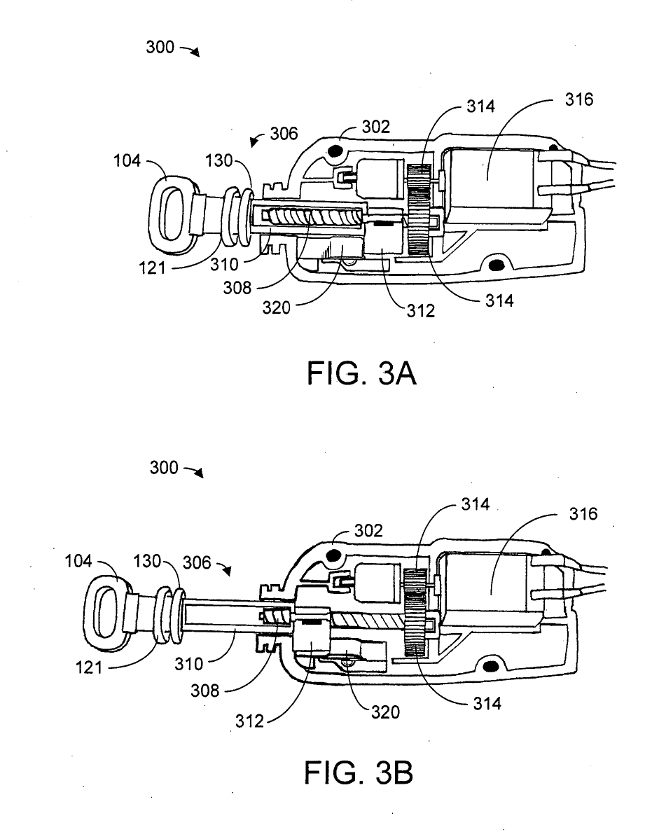

According to the present invention, however, a key and slot assembly, shown in FIG. 2, allows the nosepieces to be easily replaced, either because the original has been damaged or because a different type of nosepiece is required. A key slot assembly 130 is located at the end of piston 310 as shown in FIGS. 3A and 3B (away from the actuator body). Various nosepieces can slide onto the key slot assembly. A raised “key” 132 in the center of the attachment clamp 134 located on the base 121 of the nosepieces can slide into the key slot 125 to lock the nosepiece in place. In another preferred embodiment, the attachment clamp 134 on the bottom of the nosepiece does not need to have a center “key,” for example where the nosepiece is adequately held in place during use as with the nosepiece 122 suitable for attaching to an extension rod.

The present invention thus allows for great flexibility during installation. Especially where a large number of actuators are being used, installation is much easier since you don't have to have the exact number of each type of actuator. If a different type is needed for a particular lock, it is easy and inexpensive to simply change out the nosepiece. This also allows installers to carry a reduced inventory of actuators since the same basic actuator is adapted for different applications by simply changing the nosepiece.

The improved actuator of the present invention is also smaller and less expensive than prior-art actuators. According to the present invention, the actuator will use a current of 1 to ½ Amps and will open or close in 1-2 seconds. Prior art actuators closed in ½ second and required a current of 3 Amps. The lower current of the improved actuator of the present invention allows the use of a smaller (and cheaper) motor. This allows the actuator itself to have a smaller profile.

In a preferred embodiment, the actuators can be operated by a wireless switch (either a fob or a cab mounted switch) for example using infrared communication. The wireless switch is preferably battery operated and can communicate with a controller mounted inside the vehicle. The controller can communicate with the actuators by way of a wired or wireless connection.

In another preferred embodiment of the present invention, a wireless numeric keypad can be used to communicate with the actuator controller to operate the vehicle locks. The keypad can be programmed so that entry of the correct numeric code can be used to lock or unlock the various vehicle locks, either all at once or individually.

In another preferred embodiment, sequential locking can be used to limit power spikes when multiple actuators and locks are operated simultaneously. According to the present invention, when a large number of locks need to be operated at the same time, rather than activating all of the actuators simultaneously, they are sequentially activated individually or in small groups. In this way, the power spike can be reduced by more than 50% and up to 70%, eliminating the need for heavy-duty wiring and fuses.

In a preferred embodiment of the present invention, the actuating member is held in either the fully locked or fully unlocked positions by way of a compression spring and plunger assembly described in greater detail below. A typical prior art actuator makes use of a torsion spring as described in U.S. Pat. No. 5,493,881, which is cited above. This type of torsion spring tends to fail after around 20,000 cycles, long before the other components in the actuator. In contrast, the improved compression spring assembly described below will typically last more than 300,000 cycles.

FIG. 3A and FIG. 3B show an actuator according to a preferred embodiment of the present invention. One side of actuator case 302 has been removed. Actuating member 306 comprises a piston 310 with attached tab 312. Nosepiece 104 is also connected to the distal end of piston 310. Actuating member 306 is moved between a first retracted position, as shown in FIG. 3A, to a second extended position, as shown in 3B by way of threaded shaft 308. Electric motor 316 turns a series of gears 314 in order to rotate threaded shaft 308 and move actuating member 306 forward (extending away from the actuator body) or back (retracting toward the actuator body).

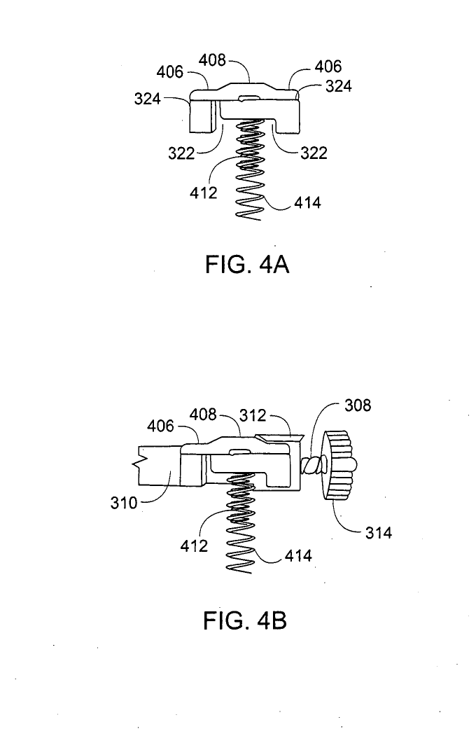

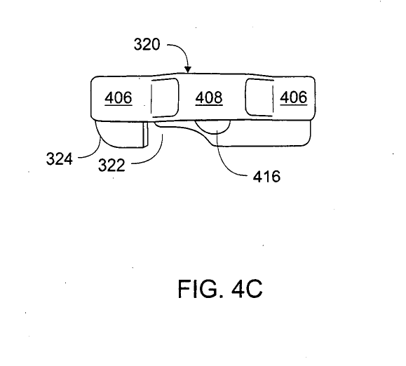

Actuator member 306 is held in either the forward or back position by way of a compression spring 402 and plunger head 320, shown in FIG. 4A. Referring also to FIGS. 3A, 3B, and 4C, the contact surface 404 of plunger head 320 (which can also be referred to as a “detent cam”) is generally rectangular in shape when viewed from above. As shown in FIGS. 4A, 4B, and 4C, plunger head 320 has a centrally located cylindrical hole 416 to receive one end of compression spring. In the embodiment shown in FIGS. 4A and 4B, the locations of notches 322 and rounded corners 324 are determined by the shape of actuator case 302. Skilled persons will recognize that these features do not directly affect the operation of the plunger head and can be varied depending on the particular actuator case that is used.

The contact surface 404 of the plunger has detents 406 at either end which slope upward to a raised center area 408. One or more compression springs exert an upward force on plunger (toward tab 312). (“Upward” in this context refers to the orientation of the actuator assembly in FIGS. 3A and 3B.) In the illustrated embodiment, a two spring configuration is employed using a shorter inner spring 412 (having a smaller diameter) which is positioned inside a longer outer spring 414 having a larger diameter. Referring also to FIGS. 3A and 3B, this pressure pushes the tab off of the rounded center portion and toward either of the two detents. This causes the actuator member to remain in either the fully extended or fully retracted positions until sufficient force is exerted (either applied manual or by way of electric motor 316) to move the actuating member to the other position. The spring and plunger apparatus preferably applies at least 2 lbs of force and more preferably applies at least 3 lbs of force to hold the actuating member in either the extended or retracted positions.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A vehicle locking apparatus comprising:
an electrically operated actuator including a base, an actuating member moveably connected to the base, and a detachable nosepiece mounted on the end of the actuating member, said nosepiece being adapted to interface with a vehicle lock mechanism to lock and unlock said mechanism.

2. The apparatus of claim 1 wherein said actuator uses a total current of 1 Amp or less.

3. The apparatus of claim 1 wherein the time required for said actuator to cause a vehicle lock mechanism to lock or unlock is 1 second or greater.

4. The apparatus of claim 1 wherein said two or more types of nosepieces can be interchangeably mounted on said actuating member, each type of nosepiece adapted to interface with a vehicle lock mechanism in a different manner.

5. A keyless vehicle locking system for electrically locking and unlocking two or more locks, said system adapted to lock or unlock the two or more locks sequentially rather than simultaneously.

6. The system of claim 5 where the sequential locking or unlocking reduces the power spike resulting from electrically locking or unlocking two or more locks by 50% or more over the power spike resulting from simultaneously locking or unlocking all locks.

7. The system of claim 5 where locking or unlocking the two or more locks sequentially comprises sequentially locking or unlocking two or more groups of locks.

8. A spring loaded actuator responsive to electrical signals and directed to use in vehicle storage compartment locking systems, comprising:
an electrically operated actuator including a base and an actuating member movably carried by said base, said actuating member comprising a piston and a threaded shaft, the rotation of said threaded shaft causing the actuating member to move between first and second positions in response to said electrical signals received by said actuator;
at least one compression spring; and
a plunger connected to said compression spring so that pressure is applied to the plunger by the spring causing said plunger to apply pressure to the actuating member, said pressure casing the actuating member to remain in either the first or second position until sufficient force is applied to move the actuating member to the other position.

9. The actuator of claim 8 wherein said sufficient force comprises approximately 3 pounds of force.

10. The actuator of claim 8 further comprising a first compression spring and a second compression spring, said second compression spring having a shorter length and smaller diameter than the first compression spring and being situated within the diameter of said first spring.

11. The actuator of claim 8 further comprising a tab connected to the shaft and oriented perpendicular to the compression spring, and wherein the plunger comprises a plunger having first and second ends and a rounded center portion raised with respect to the first and second ends, and wherein the compression spring causes the plunger to be pressed against the tab such that the pressure will cause the tab to move either toward the first or second ends of the plunger, thus applying pressure holding the actuating member in either the first or second position.

12. A keyless vehicle locking system for electrically locking and unlocking two or more locks, said system adapted to lock or unlock the two or more locks sequentially rather than simultaneously.

13. The system of claim 10 where the sequential locking or unlocking reduces the power spike resulting from electrically locking or unlocking two or more locks by 50% or more over the power spike resulting from simultaneously locking or unlocking all locks.

14. The system of claim 10 where locking or unlocking the two or more locks sequentially comprises sequentially locking or unlocking two or more groups of locks.
